(19) United States
(12) Patent Application Publication
(10) Pub. No.: US 2020/0206057 A1
(43) Pub. Date: Jul. 2, 2020

(54) COFFINS

(71) Applicant: ECOFFINS (UK) LLP, Sittingbourne, Kent (GB)

(72) Inventor: WIlliam WAINMAN, Sittingbourne (GB)

(21) Appl. No.: 16/642,088

(22) PCT Filed: Aug. 28, 2018
(86) PCT No.: PCT/EP2018/073157

§ 371 Date: Feb. 26, 2020

(51) Int. Cl. A61G 17/007; A61G 17/04

(52) U.S. Cl. CPC A61G 17/0073; A61G 2203/90; A61G 17/042; A61G 17/041

(57) ABSTRACT

The present invention relates to coffins. We describe frameless coffin comprising a coffin body fabricated from a sheet material and a coffin outer sleeve formed from a woven material. The coffin body comprises a base and a continuous wall extending generally perpendicularly from the base. The coffin outer sleeve is baseless. The sheet material is suitably a sheet material formed of a fluted corrugated sheet and one or two flat linerboards. In particular, the sheet material is suitably a fibreboard, paperboard, containerboard or cardboard sheet material, preferably a corrugated fibreboard, paperboard, boxboard or cardboard. Preferably the coffin body comprises at least two layers of the sheet material.

The present invention relates to coffins.

There are many designs and constructions of coffins known throughout the world. The present invention is concerned with coffins made from traditional, sustainable materials, such as bamboo, willow and pandanus, woven to form the shell of the coffin. The term coffin as used in respect of the present invention is not intended to be limited to any particular shape or style of funerary box and is intended to compass products which may also be referred to as caskets as well as to other funerary containers for a corpse.

Coffins made by weaving natural fibrous plants such as bamboo, banana cord, seagrass, pandanus and willow, amongst a wide range of other materials, are well known. Such coffins are expensive and are bulky for storage and transport purposes. Additionally, although cardboard coffins are known (the term cardboard encompasses, in this field and within this application, materials also known as corrugated fibreboard, containerboard and paperboard, as well as cardboard), the appearance of such coffins can be less attractive than other constructions, despite their obvious environmental advantages. The present invention seeks to provide a coffin which overcomes these disadvantages, removing the need for an expensive frame and time consuming construction.

Additionally, a fully cardboard coffin, whilst being seen as very environmentally-friendly, is seen by some to be too cheap or disrespectful. The present invention seeks to provide a coffin which maintains the environmental credentials of a cardboard coffin but improves on its external aesthetics.

In its broadest sense, the present invention provides a coffin comprising a coffin body fabricated from a sheet material and a coffin outer sleeve formed from a natural fibrous material.

The coffin is frameless, in the sense that it does not have a frame or substructure to which the coffin body sheet material is attached.

The coffin body comprises a base and a wall, wherein the wall is a continuous wall and extends generally perpendicularly from the base.

Preferably, the coffin outer sleeve is baseless. Accordingly, the coffin outer sleeve does provide or form any part of the base of the coffin.

Preferably, the coffin outer sleeve is formed of a woven natural fibrous material.

Preferably, the coffin further comprises a coffin lid. Suitably, the coffin lid is formed of a woven natural fibrous material.

Preferably, the sheet material is a material formed of a fluted corrugated sheet and one or two flat linerboards.

Preferably, the sheet material is a fibreboard, paperboard, containerboard or cardboard sheet material. More preferably a corrugated fibreboard, paperboard, boxboard or cardboard.

Preferably, the coffin body comprises at least two layers of the sheet material.

More preferably, the at least two layers of the sheet material are formed of a corrugated material in which the flutes of the corrugations of each layer are offset with respect to each other, optionally offset by 90° to each other.

Preferably the woven natural fibrous material is one or more materials selected from bamboo, banana cord, seagrass, pandanus, willow, water hyacinth, rattan, coco stick, kubu, mendong , wicker and wool, fabrics or cloth.

Alternatively, the fibrous material may be formed from recycled wood or thin bentwood.

Advantageously, the coffin further comprises a plurality of handles for use in lifting the coffin, wherein the handles are assembled to pass through the coffin outer sleeve and the coffin body.

The above and other aspects of the present invention will now be described in further detail, by way of example only, with reference to the accompanying drawings, in which:

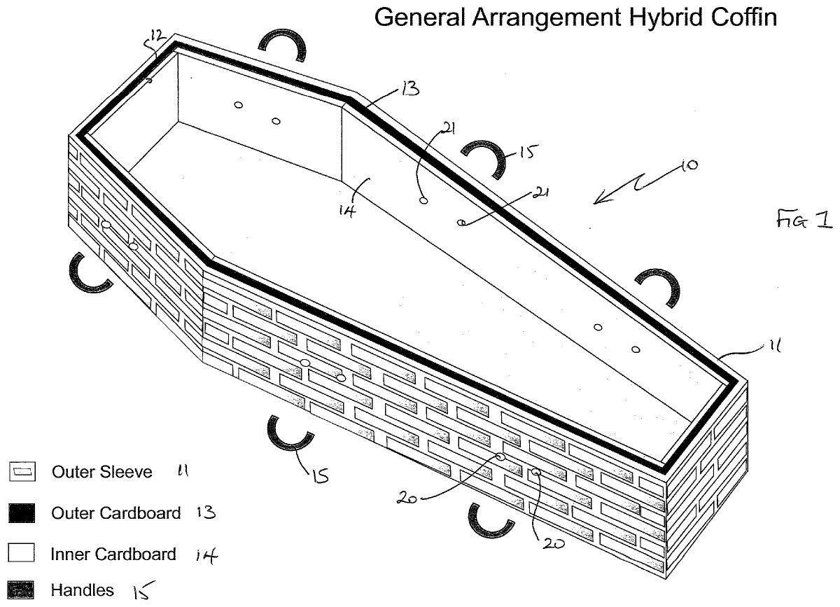

FIG. 1 is a schematic general perspective view of an embodiment of a coffin in accordance with the present invention;

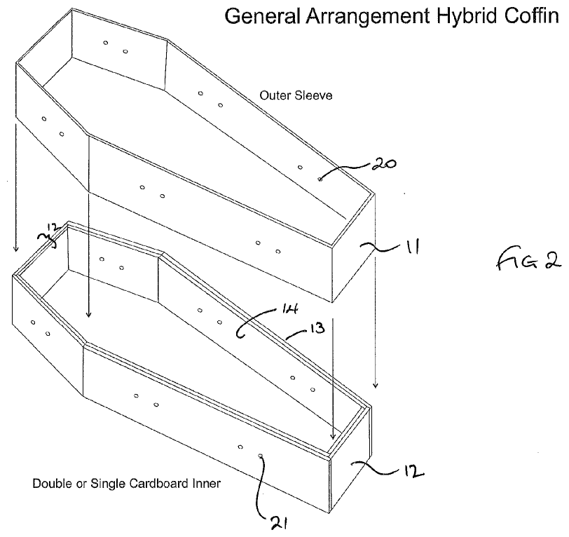

FIG. 2 is a schematic perspective view of the coffin of FIG. 1, partially disassembled;

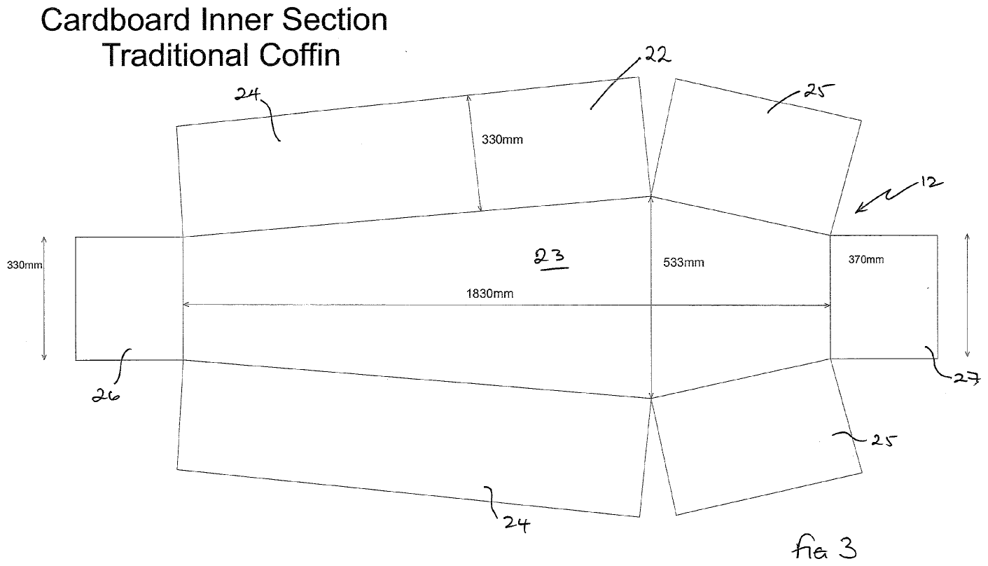

FIG. 3 shows, in plan view, the blank for the liner of the coffin of FIG. 1;

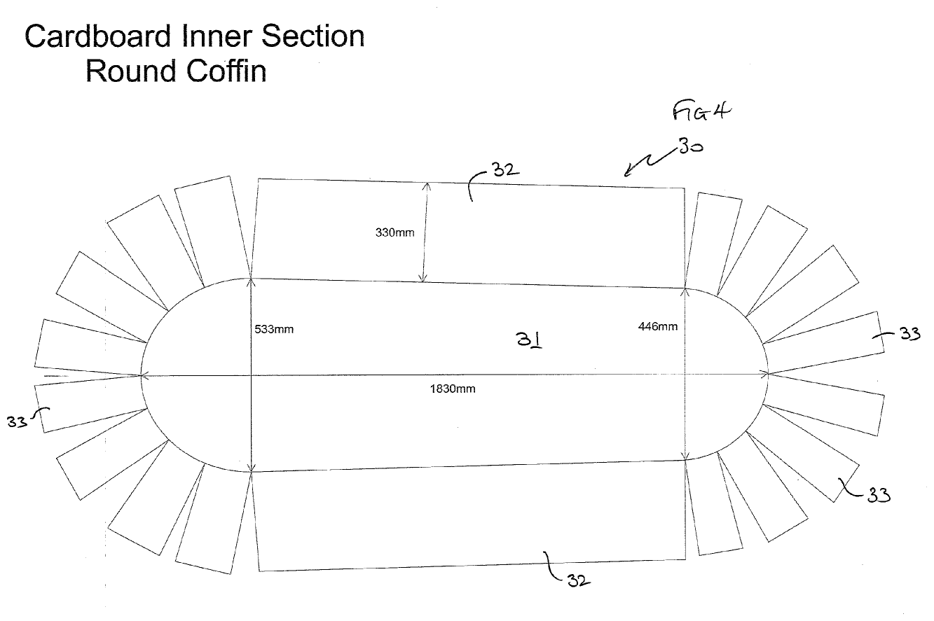

FIG. 4 shows, in plan view, a blank for a liner in accordance with the present invention for a round-ended style coffin;

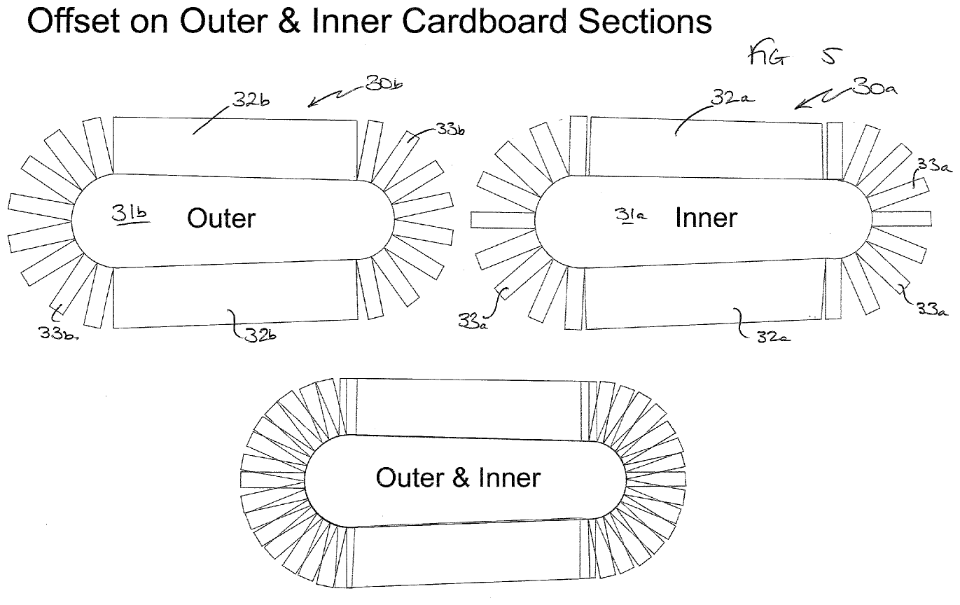

FIG. 5 shows, in plan view, inner and outer liner blanks for a first embodiment of a twin layered liner of the type shown in FIG. 4;

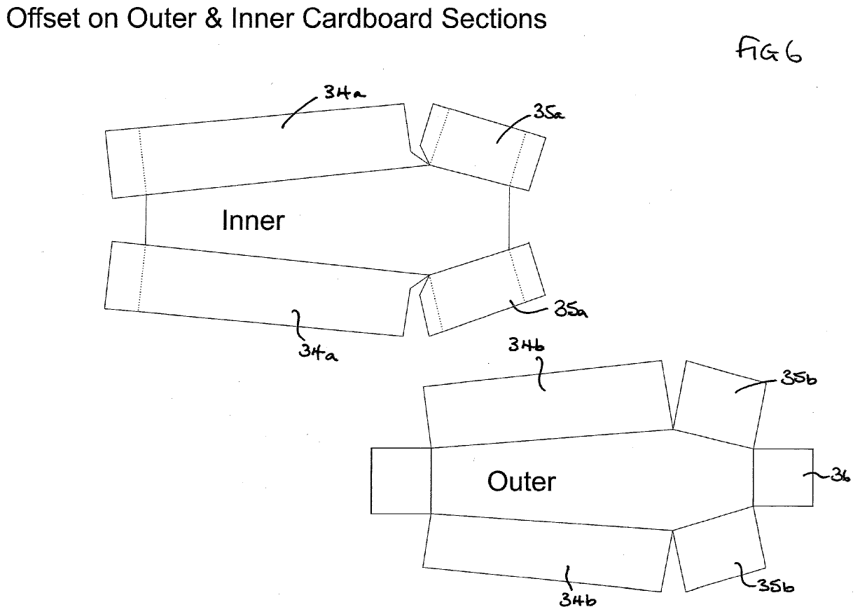

FIG. 6 shows, in plan view, inner and outer liner blanks for a second embodiment of a twin layered liner of the type shown in FIG. 4; and

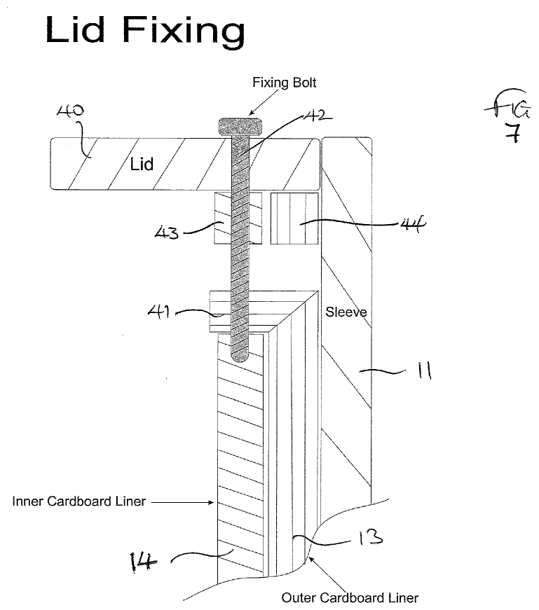

FIG. 7 is a partial cross-sectional view of a coffin of the present invention illustrating a lid fixing arrangement.

Referring to FIG. 1, an embodiment of a coffin 10 in accordance with the present invention includes an outer sleeve 11 and a coffin body 12. In the embodiment shown, the coffin body 12 is formed of first and second coffin body layers 13,14. In alternative embodiments (shown, for example in FIG. 4), the coffin body 12 is formed of a single inner sleeve layer.

Outer sleeve 11 is formed as a band which encircles, in the assembled coffin, the coffin body 12.

In preferred embodiments, the or each of the coffin body layers is formed of a sheet material formed of a fluted corrugated sheet and one or two flat linerboards. Suitably, the sheet material is a fibreboard, paperboard, containerboard or cardboard sheet material, particularly a corrugated fibreboard, paperboard, containerboard or cardboard.

The or each layer of the coffin body may be formed of a laminate sheet material having a plurality of fluted corrugated sheets, typically two fluted corrugated sheets with an intermediate liner sheet and an outer linerboard to each face thereof.

As is conventional, coffins of the present invention are provided with a plurality of handles 15 linearly spaced along each long side of the coffin 10. The handles may be used to assist in manoeuvring the coffin or may be intended to be purely decorative. The handles are typically formed of the same material as that of the outer sleeve 11 or from an alternative material such as rope. Conveniently, the handles pass through outer apertures 20 in the outer sleeve 11 and aligned inner apertures 21 in the coffin body 12 and are secured on the inner face of the coffin body. By this method, the outer sleeve 11 is secured to the coffin body 12 and the layers of the two components held resiliently together.

In alternative embodiments (not shown), the outer sleeve 11 is woven together with the layer or layers of the coffin body 12 or secured thereto by alternative techniques, such as stitching.

The coffin body and outer sleeve may, as shown in FIGS. 1 and 2, be dimensioned to be flush with one another in terms of height. In alternative embodiments, the outer sleeve 11 may have a lower height to allow the rim of the lid of the coffin to overlap the coffin body whilst remaining flush with the surface of the base of the coffin.

Alternatively, the outer sleeve 11 may sit taller than the cardboard to allow a rimless lid to rest inside the edge of the sides of the woven sleeve, to lie flush with the top of the woven sides.

FIG. 2 shows the embodiment of FIG. 1 in a partially exploded view, with the outer sleeve 11 spaced from the coffin body 12.

FIG. 3 shows the layout of the cardboard blank 22 for forming a coffin body layer 12 for a six-sided traditionally-shaped coffin of the present invention. The blank has a central or base portion 23 defining the overall shape of the coffin and defining the base of the coffin, together with flaps extending therefrom defining coffin side flaps having body side portions 24 and head side portions 25, divided at a shoulder point, a foot flap 26 and a head or top flap 27. It will be appreciated that the dimensions of the coffin body layer and of the coffin itself will be selected having regard to the dimension of the corpse. The dimensions given in FIG. 3 are indicative and are not intended to be limiting on the scope of protection.

FIG. 4 shows the layout of a cardboard blank 30 for forming a coffin body layer of a round-ended coffin. The blank has a base portion 31, combined body and head side flaps 32 and end portions, divided into a plurality of end portion elements 33 to allow forming of the blank into the round-ended shape of the coffin.

FIGS. 3 and 4 show that the blanks for the coffin body of the coffins of the present invention can be formed as simple foldable blanks, with single flaps extending from the base portion, in contrast to blanks for conventional cardboard coffins which must include additional extension flaps extending from the shape-defining flaps, which allow the base to be assembled into the structure of the coffin and provide rigidity to the coffin. In contrast, the outer sleeve 11 of the coffins of the present invention provides the required support and rigidity to the coffin structure.

The drawings show a coffin in which the outer sleeve 11 is illustrated as having a continuous construction, in which the walls of the outer sleeve are formed as a single continuous piece, as is well known in wicker and similar constructions. It will be appreciated that, as with such woven products, the wall may be formed of discrete panels joined together in any conventional manner, such as by stitching or gluing

FIG. 5 shows a modification of the coffin body formed of two identical blanks as shown in FIG. 4. In this embodiment two blanks 30a, 30b representing inner and outer blanks, are provided, each having respective end portion elements 33a, 33b. In the preferred embodiments, the slits formed to allow curved shaping of the coffin ends are offset between the inner and outer coffin body layers such that, when overlapped and assembled into the coffin body, end portion elements 33a of the inner blank 30a overlap those 33b of the outer blank 30b to provide additional rigidity and strength. The overlap also provides a visual block to any possibility of being able to see the inside of the coffin from the outside.

FIG. 6 shows an alternative modification, applied to a straight-sided coffin, in which inner and outer cardboard blanks are formed with panels 34a, 34b, 35a,35b corresponding to the long and short edges of the base, together with a head panel 36 to one of the blanks. As illustrated, the panels of the inner blank are formed with side flaps or panels. It will be appreciated that the side flaps or panels can be provided to either blank.

FIG. 7 illustrates a method or construction by which a coffin lid 40 can be secured to the coffin body. In the arrangement illustrated, it will be observed that the outer coffin body layer 13 is provided with a lip 41 which is folded over to overlay inner coffin body layer 14. A fixing member in the form of a bolt, screw or pin 42 passes through lid 40, and lip 41 of outer coffin body layer 13 and is received by a channel formed by the flutes of inner coffin body layer 14. Lip 41 is formed only in those areas where fixing member 42 is to be received. For example, lip 41 is formed by forming an inverted U-shaped cut in the outer coffin body layer 13 to form a flap. A corresponding aperture is formed in the inner coffin body layer 14 . The flap is folded over and through the inner coffin body layer. References 43 and 44 respectfully indicate the continuing portion of the inner and outer coffin body layers above the fixing location. A plurality of fixing members and corresponding fixing points are provided spaced around the upper edge of the coffin.

In preferred embodiments, fixing member 42 is formed having a non-smooth surface in order to aid frictional retention of the fixing member within the material of the coffin body. In certain embodiments, the fixing member is in the form of a threaded member.

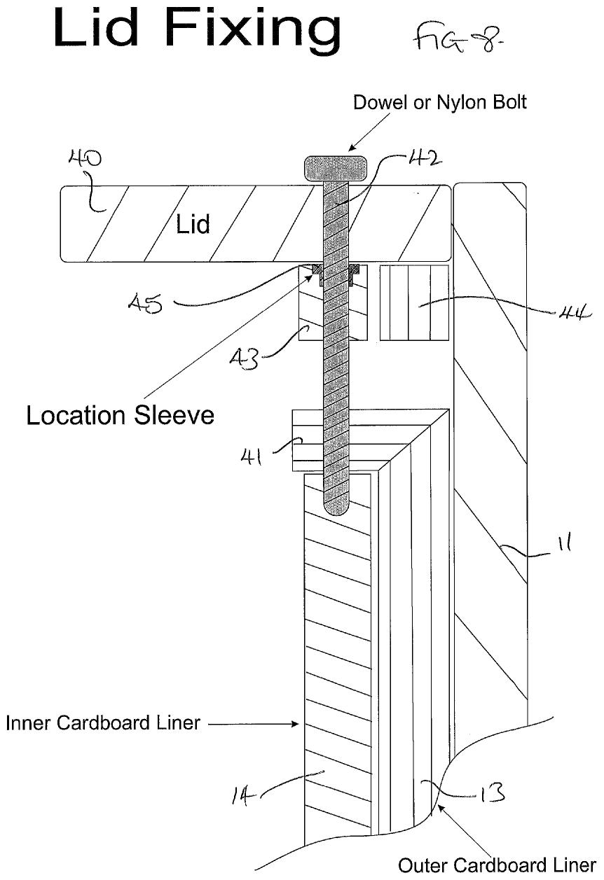

FIG. 8 shows a variation of the embodiment of FIG. 7 in which a location sleeve 45 is provided in tab 43 to enhance further the retention of fixing member 42 to lid 40. Location sleeve 45 can be formed of any suitable material, preferably a natural material, such as cork, or compressed card. Synthetic materials can equally be used, but this is not preferred from an environmental perspective. A similar location sleeve can be provided in the lid 40.

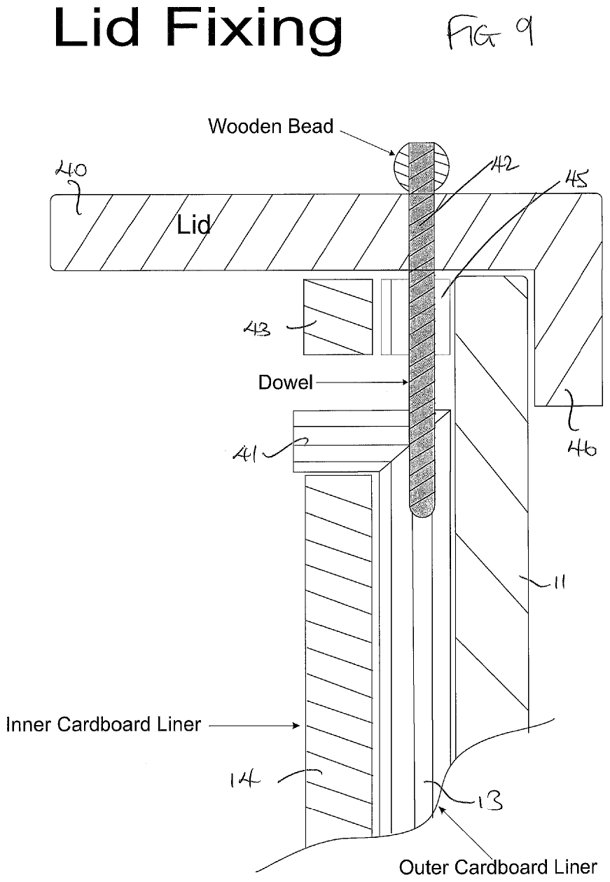

FIG. 9 shows a further modification in which the lid 40 is dimensioned to overlay the coffin body and is provided with a depending rim 46. With such a construction, fixing member 42 can be moved further to the edge of the coffin body such that it can be arranged to pass through the outer coffin body layer 13. A different design of fixing member 42 is also shown, comprising a wooden bead attached to the pin body. In alternative embodiments, not shown, the fixing member can be arranged to pass through the side walls of the coffin, namely the coffin outer sleeve and the walls of the coffin body.

In alternative embodiments, not shown, lip 41 is omitted and fixing member 42 passes simply into the flutes of the inner or outer coffin body layer.

Coffins of the present invention provide a number of advantages over the prior art, despite being able to be manufactured to have exactly the same external appearance as any existing design and be manufactured from exactly the same materials as existing constructions. The manufactured cost can be 25-30% cheaper. The coffins use far less material and have lower labour overheads than traditional coffin constructions, which require handmade frames and bases. Additionally, less storage space is required as the liner can, as with other cardboard products, be kept flat for transportation and storage, leading to lower costs and a lower environmental overhead.

Coffins manufactured exclusively from cardboard can have a high china clay content which leads to a high quantity of ash during cremation, which is disliked by the crematoria. A purely woven coffin needs a complex frame, which is time-consuming to make, to give strength to its sides and base. However, we have found that cardboard has sufficient strength to form the superstructure of the coffin such that the woven outer sleeve of our coffin can be purely decorative.

Additionally, cardboard coffins are very easily damaged, but are impossible to repair. With the coffins of the present invention, damage to the cardboard is entirely hidden by the woven outer sleeve.

1. A frameless coffin comprising a coffin body fabricated from a sheet material and a baseless coffin outer sleeve formed from a woven material; wherein the coffin body comprises a base and a wall wherein the wall is a continuous wall and extends generally perpendicularly from the base; wherein the coffin body comprises at least two layers of the sheet material; and further comprising a plurality of handles arranged linearly around at least sides of the coffin, wherein the handles are assembled to pass through the coffin outer sleeve and the coffin body.

2. (canceled)

3. (canceled)

4. (canceled)

5. A coffin as claimed in claim 1 further comprising a coffin lid comprising a woven natural fibrous material.

6. (canceled)

7. A coffin as claimed in claim 1 wherein each sheet material is a sheet material formed of a fluted corrugated sheet and one or two flat linerboards.

8. A coffin as claimed in claim 1 wherein each sheet material is a fibreboard, paperboard, containerboard or cardboard sheet material, preferably a corrugated fibreboard, paperboard, boxboard or cardboard.

9. (canceled)

10. A coffin as claimed in claim 1 wherein the at least two layers of the coffin body are formed of a corrugated material in which the flutes of the corrugations of each layer are offset with respect to the flutes of the corrugations of each adjacent layer.

11. A coffin as claimed in claim 1 wherein the coffin outer sleeve is formed from a woven natural fibrous material.

12. A coffin as claimed in claim 11 wherein the woven natural fibrous material is one or more materials selected from bamboo, banana cord, seagrass, pandanus, willow, water hyacinth, rattan, coco stick, kubu, mendong and wicker; or a fabric or cloth.

13. (canceled)

14. (canceled)

15. A coffin as claimed in claim 1 wherein the coffin body is formed of a blank consisting of a central portion defining a base to the coffin body, and a plurality of flaps extending from the central portion; characterised in the flaps do not include foldable extensions.
